(19) United States
(12) Patent Application Publication
(10) Pub. No.: US 2007/0090623 A1
(43) Pub. Date: Apr. 26, 2007

(54) ARRANGEMENT FOR SUSPENDING A LEAF SPRING ON A VEHICLE

(75) Inventors: Stefan PREIJERT, Göteborg (SE); Luis SPRATLEY, Matosinhos (PT)

Correspondence Address: NOVAK DRUCE & QUIGG, LLP;(VOLVO PROSECUTION), 1000 LOUISIANA STREET, SUITE 5300, HOUSTON, TX, 77002, US

(73) Assignee: VOLVO LASTVAGNAR AB, (SE)

(21) Appl. No.: 11/612,463

(22) Filed: Dec. 18, 2006

Related U.S. Application Data
(63) Continuation of application No. PCT/SE04/00889, filed on Jun. 10, 2005.

(30) Foreign Application Priority Data
Jun. 16, 2004 (SE) 0401583-0

(51) Int. Cl. B60G 11/00; F16F 1/26

(52) U.S. Cl. 280/124.175; 267/260

(57) ABSTRACT

Method and arrangement for suspending a leaf spring (1) on a vehicle (7), which arrangement includes a suspension member (3), which, at a first end (4), is connectable to a rear end (5) of a leaf spring (1) and, at a second end (6), is connectable to a vehicle (7) for suspension of a leaf spring (1) on a vehicle. The suspension member (3) is provided with a built-in weakening (16) so as, in the event of a predetermined loading of the suspension member (3), and when the leaf spring (1) is connected to a vehicle (7) by way of the suspension member (3), to allow the suspension member (3) to collapse while the rear end (5) of the leaf spring (1) is moved rearward substantially past its, in normal running, rearmost position and/or is set free from the vehicle (7).

### CROSS-REFERENCE TO RELATED APPLICATIONS

The present application is a continuation patent application of International Application No. PCT/SE2005/000889 filed 10 Jun. 2005 which is published in English pursuant to Article 21(2) of the Patent Cooperation Treaty and which claims priority to Swedish Application No. 0401583-0 filed 16 Jun. 2004. Said applications are expressly incorporated herein by reference in their entirety.

### FIELD

The present invention relates to methods and arrangements for suspending a leaf spring on a vehicle.

### BACKGROUND

Leaf spring devices for the spring-loaded suspension of vehicle wheel axles, preferably for wheels in trucks, are usually provided with a front and a rear mounting for suspension of a leaf spring assembly disposed between these mountings on a vehicle frame. The leaf spring assembly can be rotatably connected to the mountings. The rear mounting often comprises two pivot points and an intervening link which allows the leaf spring assembly to be displaced somewhat to the rear (and back again) along the longitudinal direction of the vehicle in the event of elastic deflection. The leaf spring assembly further has some form of means for coupling together the leaf spring and a vehicle wheel axle at a position situated between the front and rear mounting.

Examples of such leaf spring devices are described in EP 955467 and JP 61075005.

In line with the ever greater safety requirements which are placed upon trucks, such as demands for longer deformation zones, the individual parts of the vehicles are required to be configured such that they behave as favorably as possible in the event of any collision. In a collision involving a truck, however, a leaf spring device according to the prior art which is disposed on a truck tends to break in an undesirable manner. Usually, the front mounting of the leaf spring breaks and then the leaf spring assembly is bent away rearward in relation to the vehicle.

Such a spring assembly, which is connected to the vehicle frame by the rear mounting, does though have a relatively high bending resistance, so that the force which is needed during a collision to bend away and/or deform the spring assembly, which, during the collision, can also end up resting against other components of the vehicle, makes a not insubstantial contribution to the overall deformation characteristics of the vehicle.

### SUMMARY

One object of the invention is to provide an arrangement of the type described in the introduction, which arrangement is more favorable with respect to its deformation characteristics should the arrangement be subjected to load during a collision.

The fact that the suspension means of the arrangement is provided with a built-in weakening 16 so as, in the event of a predetermined (pre-specified) loading of the suspension means 3, and when the leaf spring 1 is connected to a vehicle 7 by means of the suspension means 3, to allow the suspension means 3 to collapse while the rear end 5 of the leaf spring 1 is moved rearward substantially past its, in normal running, rearmost position and/or is set free from the vehicle, means that the resistance from the leaf spring during a collision will be substantially reduced, which, in turn, can help to create a longer collision zone, for example in the front part of a truck.

Other advantageous distinguishing features and functions of various embodiments of the invention emerge from the following description and patent claims.

### BRIEF DESCRIPTION OF THE DRAWINGS

There follows below, with reference to the appended drawings, a detailed description of embodiments of the invention which are cited by way of example in which:

FIG. 1 is a side view of a truck provided with an inventive arrangement for suspending a leaf spring;

FIG. 1a is an enlarged view of the inventive arrangement in FIG. 1;

FIG. 2 is a part-view of a leaf spring suspension, showing a rear mounting according to the prior art for suspending a leaf spring on a vehicle frame;

FIG. 3a is a part-view of FIG. 1a, showing a rear mounting according to the invention for suspending a leaf spring on a vehicle frame;

FIG. 3b is a view corresponding to FIG. 3a, in which certain parts of the rear mounting have been omitted in order to provide clearer illustration of forces acting upon the mounting; and

FIG. 3c shows a partially cut exploded diagram of the rear mounting in FIG. 3a.

### DETAILED DESCRIPTION

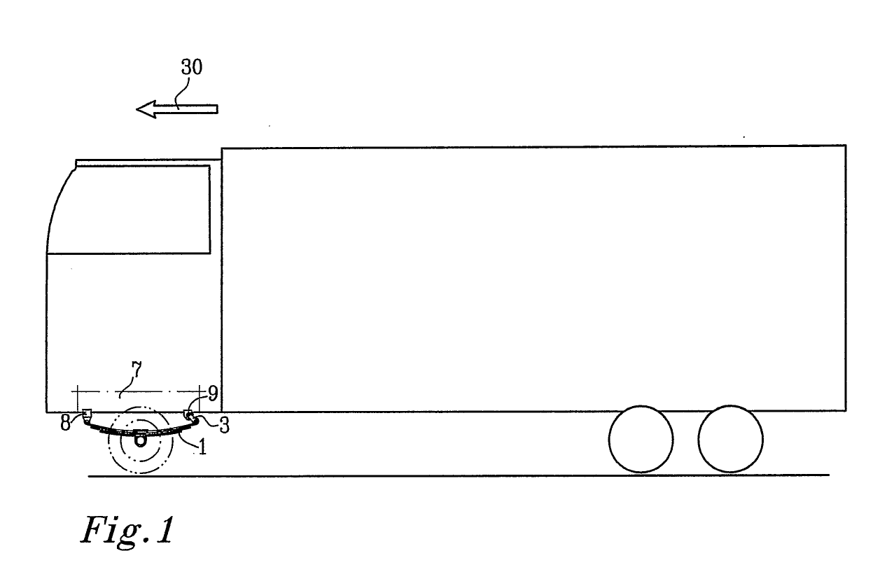

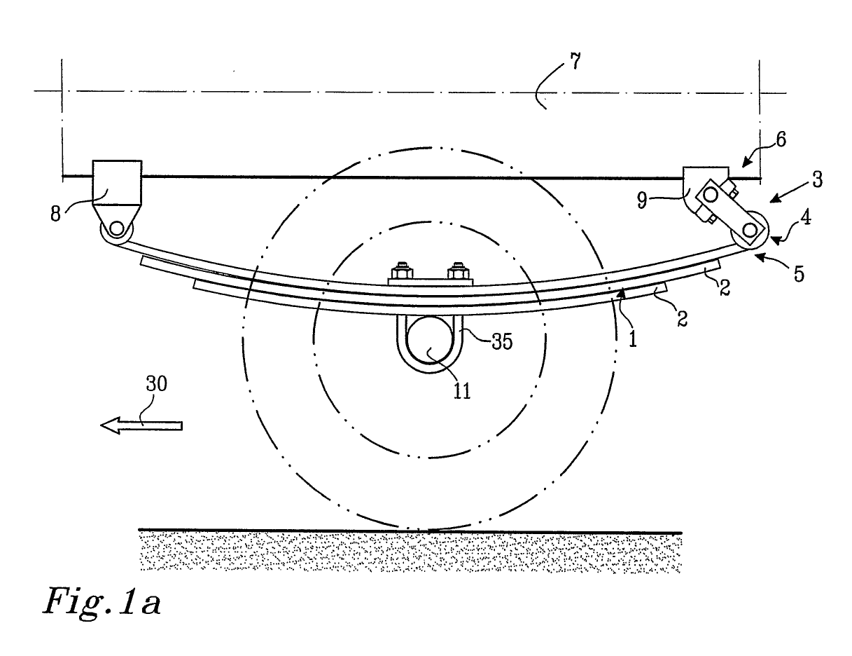

A truck provided with an inventive arrangement is illustrated in FIG. 1. A leaf spring suspension device is disposed on the front wheel axle of the vehicle. In FIG. 1a, the inventive arrangement for suspending a leaf spring 1 on a vehicle is illustrated in an enlarged view. By the term leaf spring 1 is meant one or more leaves 2 made of a resilient material, such as steel, which have been coupled together to form a resilient unit. The arrangement comprises a suspension member (means) 3, which, at a first end 4, is connectable to a rear end 5 of a leaf spring 1 and, at a second end 6, is connectable to a vehicle, for example to a vehicle frame 7, for suspension of the leaf spring 1 on the vehicle. By rear end 5 of a leaf spring 1 is meant the end which is disposed farthest back with respect to the normal direction of travel 30 of the vehicle. At the rear end 5 there is usually disposed one of normally two mountings 8, 9, disposed along the longitudinal direction of the vehicle, for the rotatable suspension of the leaf spring 1 on the vehicle. The inventive arrangement constitutes the rear mounting 9. The leaf spring 1 further has some form of means 35 for coupling together the leaf spring 1 and a vehicle wheel axle 11 at a position situated between the front 8 and the rear mounting 9.

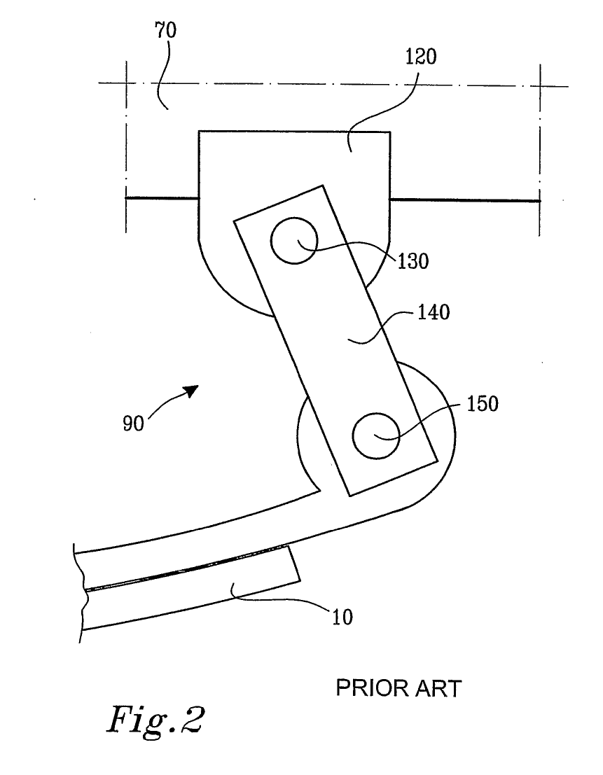

A rear mounting 90 configured according to the prior art is illustrated in FIG. 2. The mounting 90 has a first component 120, which is fastened to a vehicle frame 70 and which is provided with an axle journal 130 for rotatable suspension of the leaf spring 10. The first component 120 and the leaf spring 10 are connected by a link arm 140, which is disposed between the first axle journal 130 and a second axle journal 150 of the leaf spring 10.

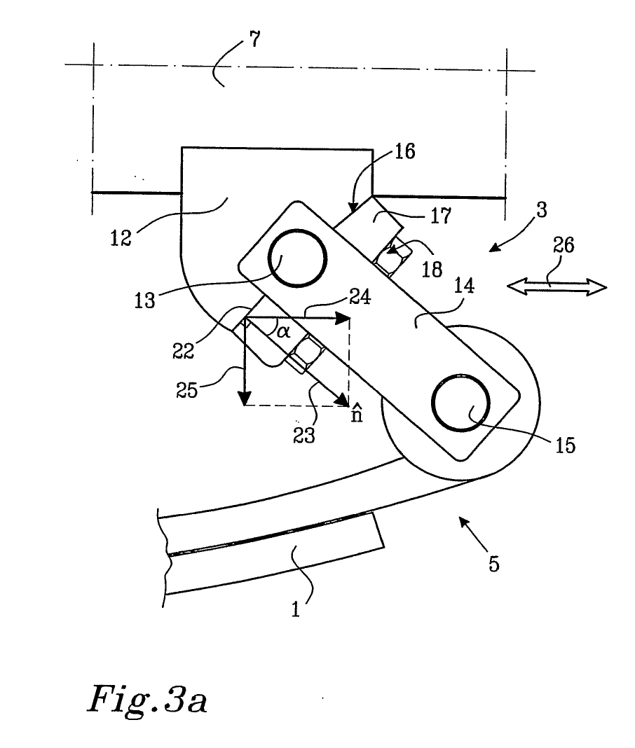

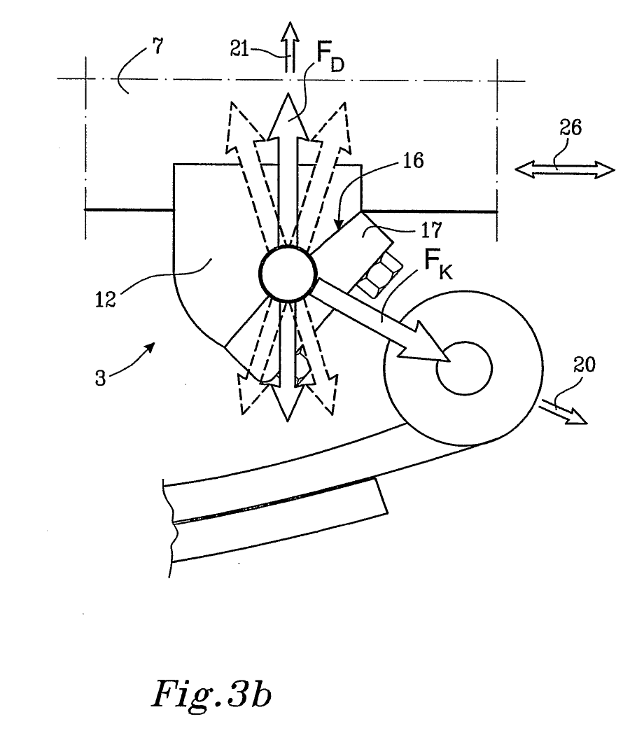

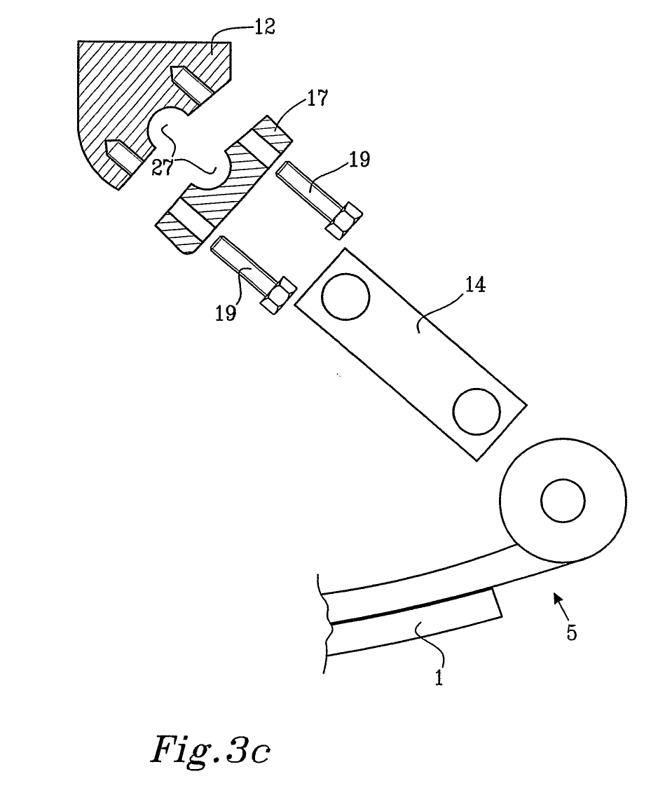

In FIGS. 3a, 3b and 3c, an inventive arrangement is shown in which the suspension means 3 is provided with a built-in weakening 16 so as, in the event of a predetermined loading of the suspension means 3, to allow the suspension means 3 to collapse. The suspension means 3 is provided with the built-in weakening 16 so as, in the event of said predetermined loading of the suspension means 3, and when the leaf spring 1 is connected to a vehicle, such as to a vehicle frame 7, by means of the suspension means 3, to allow the suspension means 3 to collapse while the rear end 5 of the leaf spring 1 is moved rearward substantially past its, in normal running, rearmost position and/or is set free from the vehicle 7.

This means that the inventive suspension means 3, unlike the mounting 90 according to the prior art (illustrated in FIG. 2), is designed to collapse in a predictable manner should a predetermined force act upon the suspension means 3 in a predetermined direction. Such a suspension means 3 can contribute to a desired force transmission and a desired deformation zone in a vehicle on which the particular leaf spring 1 is disposed.

According to the invention, the rear end 5 of the leaf spring 1 can therefore be moved to a position situated beyond the rearmost position which might be reached through the arrangement of a link arm 14 or corresponding component, and preferably the rear end 5 can be set free from the vehicle, so that the leaf spring 1, if the front mounting 8 breaks, can be moved rearward, while the rear mounting 9, and therefore the leaf spring 1 as a whole, makes no or only a minor contribution to the deformation strength of the vehicle in a collision. By rearward movement is here meant, therefore, movement in a substantially opposite direction to the normal direction of travel 30 for a vehicle.

In order to achieve the collapsing function of the suspension means 3, the suspension means 3 preferably comprises a first component 12, which is connectable to the vehicle 7, and a second component 17, which is connectable to a rear end 5 of a leaf spring 1, and further comprises a member 18, which is arranged to connect the first 12 and second 17 component. The connecting member 18 is here arranged to collapse in the event of said predetermined load, so that the first 12 and second component 17 are separable from one another. Although the connecting member 18 is preferably a screw joint containing one or more screws 19, other connections might also be possible. For example, riveting, welding or some other joining method might be used to join the two components 12, 17 in the desired way. It would also be possible to-produce the two components 12, 17 in one and the same piece if a part of the piece constituting the connecting member is formed with a substantially lower strength than the remainder of the first and second component and/or if a notch is provided so that, in the event of said predetermined load, the connecting member breaks in a predictable manner so that the two components are separated.

As in the illustrated embodiment, the arrangement can further comprise a first axle journal 13, which is preferably disposed between the first component 12 and the second component 17, a second axle journal 15 of the leaf spring 1, and a link arm 14 arranged to connect the second component 17 to the leaf spring 1 by the first and the second axle journal. The suspension means 3 can comprise such a link arm 14 for rotatable suspension of the leaf spring 1.

Cases occur in which it is desirable that the force F_{K}, see FIG. 3b, which will cause the collapse of the suspension means 3 is less than the force F_{D} which will be able to be transmitted between the leaf spring 1 and a vehicle in normal running. In such a case, it is necessary for the suspension means 3 to be adapted to collapse upon application of a minimal force F_{K} only if the force were to be applied in a certain predetermined direction 20, or within a predetermined range of direction, which direction 20 is substantially different than the principal force transmission direction 21 of the suspension means. By principal force transmission direction 21 is meant the direction in which the maximal forces F_{D} are transmitted during normal running. Usually, the maximal forces which are transmitted between the leaf spring 1 and the vehicle during normal running of a leaf-spring-suspended wheel are directed substantially vertically upward 21.

It is advantageous for the suspension means 3 to be adapted for suspension on a vehicle such that the interface between the first 12 and second component 17 has a principal extent in a plane 22 whose normal 23 has a component 24 directed horizontally rearward and a component 25 directed vertically downward in relation to the vehicle, see FIG. 3a. Preferably, said horizontal component 24 is directed substantially parallel with the extent of the vehicle 7 in the longitudinal direction.

The normal 23 can have a direction forming an angle α ranging from 0 to 60° in relation to a horizontal line 26 (which is parallel with the direction of travel 30 for the vehicle), and it preferably has a direction forming an angle α ranging from 20 to 45° in relation to the horizontal line 26. The suspension means 3 is preferably adapted to receive an axle journal 13 for force transmission between a vehicle 7 and a leaf spring 1. In the event of a load less than said predetermined load, the connecting member 18 is arranged to hold together the first 12 and second component 17 so as to detain the axle journal 13 between the first 12 and second 17 component. The first component 12 and/or the second component 17 can be provided with a recess 27 for receiving the axle journal 13.

FIG. 3b illustrates, for the exemplification of the invention, forces F_{K}, F_{D} of an inventive suspension means 3 which is adapted to collapse upon application of a minimal force F_{K} in a direction 20 which is substantially different than the vertical direction 21. The size of the force F_{K} for which the suspension means 3 is adapted to collapse is less than the force F_{D} which the suspension means 3 is capable of transmitting from a leaf spring 1 to the vehicle 7 in said principal force transmission direction 21. The suspension means 3 is in this case adapted to collapse upon application of a force F_{K} in a direction substantially parallel, or almost parallel, with said normal 23 of the plane 22 between the first 12 and second 17 component upon application of a minimal force F_{K} chosen from within the range 10-40 kN. The arrangement is further adapted for suspension of a front wheel axle on a truck for transmission of a force F_{D}, from the rear end 5 of the leaf spring 1 to the vehicle 7, which force is of the order of magnitude 50 kN and is directed upward in the vertical direction 21.

The invention also relates to a leaf spring suspension device for a vehicle, comprising a leaf spring 1 for spring-mounted suspension of a vehicle wheel axle 11, a front mounting 8 and a rear mounting 9 for suspension of the leaf spring 1 on a vehicle, for example on a vehicle frame 7. The rear mounting 9 comprises a suspension means 3, which is provided with a built-in weakening 16 so as, in the event of a predetermined loading of the suspension means 3, and when the leaf spring 1 is connected to a vehicle 7 by means of the suspension means 3, to allow the suspension means 3 to collapse while the rear end 5 of the leaf spring 1 is moved rearward substantially past its, in normal running, rearmost position and/or is set free from the vehicle 7. The suspension means 3 of the inventive leaf spring device can here be configured in accordance with that which is described above for the suspension means 3.

It will be appreciated that the present invention is not limited to the embodiments which are described above and illustrated in the drawings; rather, the person skilled in the art will discover that many changes and modifications can be executed within the scope of protection of the appended patent claims. For example, the dimensions and the material of the components of the inventive arrangement can be varied in a number of ways. Although a device as described above, which is provided with a weakening in the form of a connecting member having relatively low strength and connecting a two-part component accommodating an axle journal, is advantageous, it should be emphasized that, in another embodiment of the arrangement, the weakening could be arranged in a different position and/or in a different component contained in the suspension device.

What is claimed is:

1. An arrangement for suspending a leaf spring (1) on a vehicle (7), said arrangement comprising:
a suspension member (3), which, at a first end (4) is connectable to a rear end (5) of a leaf spring (1) and at a second end (6) is connectable to a vehicle (7) for suspension of a leaf spring (1) on a vehicle; and
said suspension member (3) is provided with a built-in weakening (16) so that in the event of a predetermined loading thereof, and when the leaf spring (1) is connected to a vehicle (7) by said suspension member (3), said suspension means (3) is allowed to collapse while the rear end (5) of the leaf spring (1) is moved rearward substantially past a normal running rearmost position for being set free from the vehicle (7).

2. The arrangement as recited in claim 1, wherein the suspension member (3) comprises a first component (12) connectable to a vehicle (7) and a second component (17) connectable to a rear end (5) of a leaf spring (1) and a connecting member (18), which is arranged to connect the first (12) and second (17) component, is arranged to collapse in the event that said predetermined load is experienced and whereby the first and second components (12, 17) are separable from one another.

3. The arrangement as recited in claim 2, wherein the connecting member (18) is a screw joint.

4. The arrangement as recited in claim 1, wherein the suspension member (3) comprises a link arm (14) for rotatable suspension of a leaf spring (1).

5. The arrangement as recited in claim 2, wherein the suspension member (3) is adapted for suspension on a vehicle (7) such that the interface between the first (12) and second (17) component has a principal extent in a plane (22) whose normal (23) has a component (24) directed horizontally rearward and a component (25) directed vertically downward in relation to the vehicle (7).

6. The arrangement as recited in claim 5, wherein said horizontal component (24) is directed substantially parallel with the extent of the vehicle in the longitudinal direction.

7. The arrangement as recited in claim 5, wherein said normal (23) has a direction such that it forms an angle (α) ranging between zero and 60° relative to horizontal (26).

8. The arrangement as recited in claim 5, wherein said normal (23) has a direction such that it forms an angle (α) ranging between 20 to 45° relative to horizontal (26).

9. The arrangement as recited in claim 2, wherein the suspension member (3) is adapted to receive an axle journal (13) for force transmission between a vehicle (7) and a leaf spring (1), the connecting member (3) being arranged to, in the event of a load less than said predetermined load, hold the first (12) and second component (17) together and thereby detain the axle journal (13) between the first and second components (12, 17).

10. The arrangement as recited in claim 9, wherein at least one of the first component (12) and the second component (17) is provided with a recess (27) for receiving the axle journal (13).

11. The arrangement as recited in claim 4, wherein the link arm (14) is disposed between the axle journal (13) and a leaf spring (1).

12. The arrangement as recited in claim 1, wherein the suspension member (3) is adapted to collapse upon application of a predetermined minimal force (F_{K}) in a direction (20) which is substantially different than the principal force transmission direction (21) of the suspension member (3) from a leaf spring (1) to a vehicle (7).

13. The arrangement as recited in claim 12, wherein the suspension member (3) is adapted to collapse upon application of a predetermined minimal force (F_{K}) in a direction (20) which is substantially different than the vertical direction (21).

14. The arrangement as recited in claim 12, wherein the magnitude of the force (F_{K}) for which the suspension member (3) is adapted to collapse is less than the force (F_{D}) under which the suspension member (3) is capable of transmitting from a leaf spring (1) to a vehicle (7) in said principal force transmission direction (21).

15. The arrangement as recited in claim 5, wherein the suspension member (3) is adapted to collapse upon application of a predetermined minimal force (F_{K}) in a direction substantially parallel with said normal (23).

16. The arrangement as recited in claim 1, wherein the suspension member (3) is adapted to collapse upon application of a predetermined minimal force (F_{K}) chosen from within the range of 10 to 40 kN.

17. The arrangement as recited in claim 1, wherein said arrangement is adapted to suspend a front wheel axle (11) on a truck.

18. A leaf spring suspension device for a vehicle, said device comprising:
a leaf spring (1) for spring-mounted suspension of a vehicle wheel axle (11), a front (8) and a rear (9) mounting for suspension of the leaf spring (1) on a vehicle (7), said rear mounting (9) comprising a suspension member (3), which is provided with a built-in weakening (16) so that in the event of a predetermined loading thereof, and when the leaf spring (1) is connected to a vehicle (7) by said suspension member (3), said suspension means (3) is allowed to collapse while the rear end (5) of the leaf spring (1) is moved rearward substantially past a normal running rearmost position for being set free from the vehicle (7).

19. A vehicle including a leaf spring suspension device for a vehicle and wherein said device comprises a leaf spring (1) for spring-mounted suspension of a vehicle wheel axle (11), a front (8) and a rear (9) mounting for suspension of the leaf spring (1) on a vehicle (7), said rear mounting (9) comprising a suspension member (3), which is provided with a built-in weakening (16) so that in the event of a predetermined loading thereof, and when the leaf spring (1) is connected to a vehicle (7) by said suspension member (3), said suspension means (3) is allowed to collapse while the rear end (5) of the leaf spring (1) is moved rearward substantially past a normal running rearmost position for being set free from the vehicle (7).
